(19) United States
(12) Patent Application Publication
(10) Pub. No.: US 2018/0147782 A1
(43) Pub. Date: May 31, 2018

(54) PRINTER

(71) Applicant: MIMAKI ENGINEERING CO., LTD., Nagano (JP)

(72) Inventors: Kosuke Kobayashi, Nagano (JP); Takuya Matsushima, Nagano (JP); Eiji Miyashita, Nagano (JP)

(21) Appl. No.: 15/816,587

(22) Filed: Nov. 17, 2017

(30) Foreign Application Priority Data
Nov. 28, 2016 (JP) 2016-229785

(51) Int. Cl. B29C 64/245; B29C 64/227; B33Y 30/00

(52) U.S. Cl. CPC B29C 64/245; B41J 2/145; B33Y 30/00; B29C 64/227

(57) ABSTRACT

To achieve an improved accuracy in vertically positioning the whole surface of a table moved upward or downward in a printer equipped with the table on which a printed matter is placeable and a lifting mechanism for moving the table upward and downward. The printer has a table on which a printed matter is placeable, a table support that supports the table in a manner that the table is movable upward and downward, lifting mechanisms that move the table upward and downward relative to the table support, and guiding mechanisms that vertically guide the table. One of the lifting mechanisms and one of the guiding mechanisms are disposed at positions on a side of the table in X1 direction and are arranged in an aligned manner in Y direction. The other one of the lifting mechanisms and the other one of the guiding mechanisms are disposed at positions on a side of the table in X2 direction and are arranged in an aligned manner in Y direction. The one of the lifting mechanisms is disposed at a position more toward Y2 direction than the one of the guiding mechanisms, and the other one of the guiding mechanisms is disposed at a position more toward the Y2 direction than the other one of the lifting mechanism.

### CROSS REFERENCE TO RELATED APPLICATIONS

This application claims the priority benefit of Japanese Patent Application No. 2016-229785, filed on Nov. 28, 2016. The entirety of the above-mentioned patent application is hereby incorporated by reference herein and made a part of this specification.

### TECHNICAL FIELD

This disclosure relates to a printer equipped with a table on which a printed matter is placeable, and a lifting mechanism that moves the table upward and downward.

### DESCRIPTION OF THE BACKGROUND ART

There are known 3D shaping printers developed to manufacture three-dimensional objects (for example, Japanese Patent No. 4794465). The 3D shaping printer described in Japanese Patent No. 4794465 has a substrate. In this printer, three-dimensional objects are formed on the upper surface of the substrate. This 3D shaping printer further has a platform to which the substrate is detachably attached, and Z lifts that move the platform upward and downward. The platform is a cuboidal member having a rectangular shape in vertical view. The substrate is attached to the upper surface of the platform. The Z lifts are, when vertically viewed, disposed at two positions on both end sides of a longer side of the rectangular platform.

### SUMMARY

In the 3D shaping printer described in Japanese Patent No. 4794465, the Z lifts for moving the platform upward and downward are, when vertically viewed, disposed at two positions on both end sides of a longer side of the rectangular platform. With the Z lifts being located at these positions, it may be difficult to vertically move the platform in a balanced manner without inclining the upper surface of the platform moved upward or downward. In this 3D shaping printer, therefore, the upper surface of the platform may fail to be vertically positioned as accurately as desired. This may lead to less accuracy in vertically positioning the substrate mounted on the upper surface of the platform. Thus, the 3D shaping printer may involve the risk of poor accuracy in vertically positioning the substrate used to form three-dimensional objects.

To address the issue, this disclosure is directed to, in a printer equipped with a table on which a printed matter is placeable and a lifting mechanism for moving the table upward and downward, achieving an improved accuracy in vertically positioning the whole surface of the table moved upward or downward.

To this end, this disclosure provides a printer including: a table on which a printed matter is placeable; a table support that supports the table in a manner that the table is movable upward and downward; a first lifting mechanism and a second lifting mechanism that move the table upward and downward relative to the table support; and a first guiding mechanism and a second guiding mechanism that guide the table in a vertical direction. When a predetermined direction orthogonal to the vertical direction is defined as a first direction, a direction orthogonal to the first direction and the vertical direction is defined as a second direction, and one of two directions included in the second direction is defined as a third direction, the first lifting mechanism and the first guiding mechanism are disposed at positions on one end side of the table in the first direction and are arranged in an aligned manner in the second direction, the second lifting mechanism and the second guiding mechanism are disposed at positions on another end side of the table in the first direction and are arranged in an aligned manner in the second direction, the first lifting mechanism is disposed at a position more toward the third direction than the first guiding mechanism, and the second guiding mechanism is disposed at a position more toward the third direction than the second lifting mechanism.

In the printer disclosed herein, the first lifting mechanism and the first guiding mechanism are arranged in an aligned manner in the second direction on one end side of the table in the first direction, and the second lifting mechanism and the second guiding mechanism are arranged in an aligned manner in the second direction on the other end side of the table in the first direction. In this printer, the first lifting mechanism is disposed at a position more toward the third direction than the first guiding mechanism, and the second guiding mechanism is disposed at a position more toward the third direction than the second lifting mechanism. In the printer disclosed herein, two lifting mechanisms and two guiding mechanisms are respectively arranged so as to diagonally face each other. These structural features may allow for balanced movements of the table in the vertical direction without inclining the upper surface of the table moved upward or downward. The printer disclosed herein may achieve a higher accuracy in vertically positioning the whole surface of the table moved upward or downward.

In the printer disclosed herein, a distance in the second direction between the first lifting mechanism and the first guiding mechanism may be equal to a distance in the second direction between the second lifting mechanism and the second guiding mechanism. This structure feature may allow for more balanced movements of the table in the vertical direction without inclining the upper surface of the table moved upward or downward. The printer thus further characterized may achieve a more improved accuracy in vertically positioning the whole surface of the table.

In the printer disclosed herein, the first lifting mechanism and the first guiding mechanism may be adjacently arranged at positions in vicinity to or at center of the table in the second direction, and the second lifting mechanism and the second guiding mechanism may be adjacently arranged at positions in vicinity to or at center of the table in the second direction. This structure feature may allow for even more balanced movements of the table in the vertical direction without inclining the upper surface of the table moved upward or downward. The printer thus further characterized may achieve an even more improved accuracy in vertically positioning the whole surface of the table.

The printer disclosed herein may further include: an inkjet head from which ink droplets are ejected toward the table; a carriage mounted with the inkjet head and disposed at an upper position than the table; and a carriage driving mechanism that moves the carriage in a main scanning direction orthogonal to the vertical direction. The first direction is the main scanning direction, and the second direction is a sub scanning direction.

In the printer disclosed herein, the first lifting mechanism and the second lifting mechanism may each have a lead screw rotatably held by the table support, and a nut member attached to the table and engageable with the lead screw, and the first guiding mechanism and the second guiding mechanism may each have a guide rail attached to the table support, and a guide block attached to the table and engageable with the guide rail.

In the printer disclosed herein, the printed matter may be a three-dimensional object. In case the printed matter is a three-dimensional object, the printer thus achieving an improved accuracy in vertically positioning the table may ensure high precision in manufacture of a three-dimensional object on the table.

The printer disclosed herein may include a eject unit that ejects a resin filament softened by heating toward the table to form the printed matter, and the printed matter is a three-dimensional object.

In the printer equipped with the table on which a printed matter is placeable and the lifting mechanism that moves the table upward and downward, a higher accuracy may be achieved in vertically positioning the whole surface of the table moved upward or downward.

### BRIEF DESCRIPTION OF THE DRAWINGS

FIG. 1 is a perspective view of a printer according to an embodiment of this disclosure.

FIG. 2 is a schematic front view of the printer illustrated in FIG. 1.

FIG. 3 is a perspective view of a stage illustrated in FIG. 1.

FIG. 4 is a schematic plan view of the stage illustrated in FIG. 1.

FIG. 5 is a bottom view, illustrating a eject unit mounted in a carriage illustrated in FIG. 1.

FIG. 6 is a front view, illustrating the eject unit illustrated in FIG. 5.

FIG. 7 is a perspective view in part of a flattening roller unit illustrated in FIG. 5.

FIGS. 8A and 8B are front views, illustrating the flattening roller unit illustrated in FIG. 7 and its operation.

FIG. 9 is a side view, illustrating supports of a flattening roller and supports of a roller holding member illustrated in FIG. 7.

FIG. 10 is a block diagram, illustrating an ink circulating mechanism and an ink collecting mechanism of the printer illustrated in FIG. 1.

FIG. 11 is a bottom view of an object-shaping table according to another embodiment of this disclosure.

FIG. 12 is a block diagram, illustrating an ink collecting mechanism according to another embodiment of this disclosure.

### DETAILED DESCRIPTION OF EMBODIMENTS

### Embodiment

An embodiment of this disclosure is hereinafter described in detail with reference to the accompanying drawings.

[Printer: Schematic Structure]

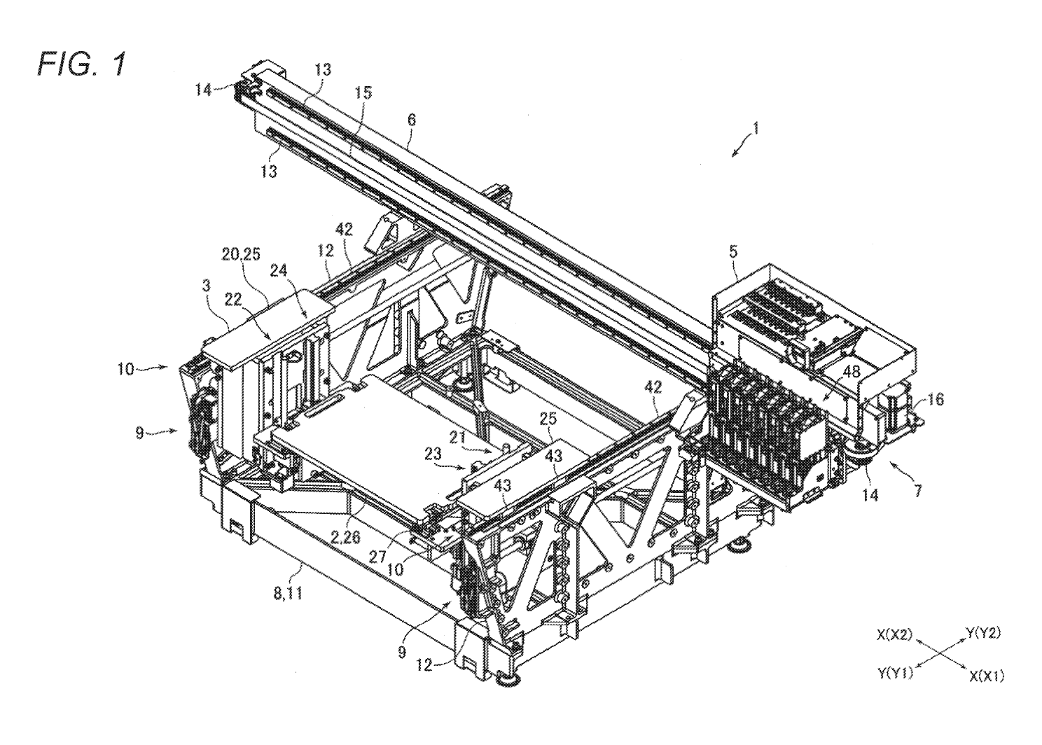

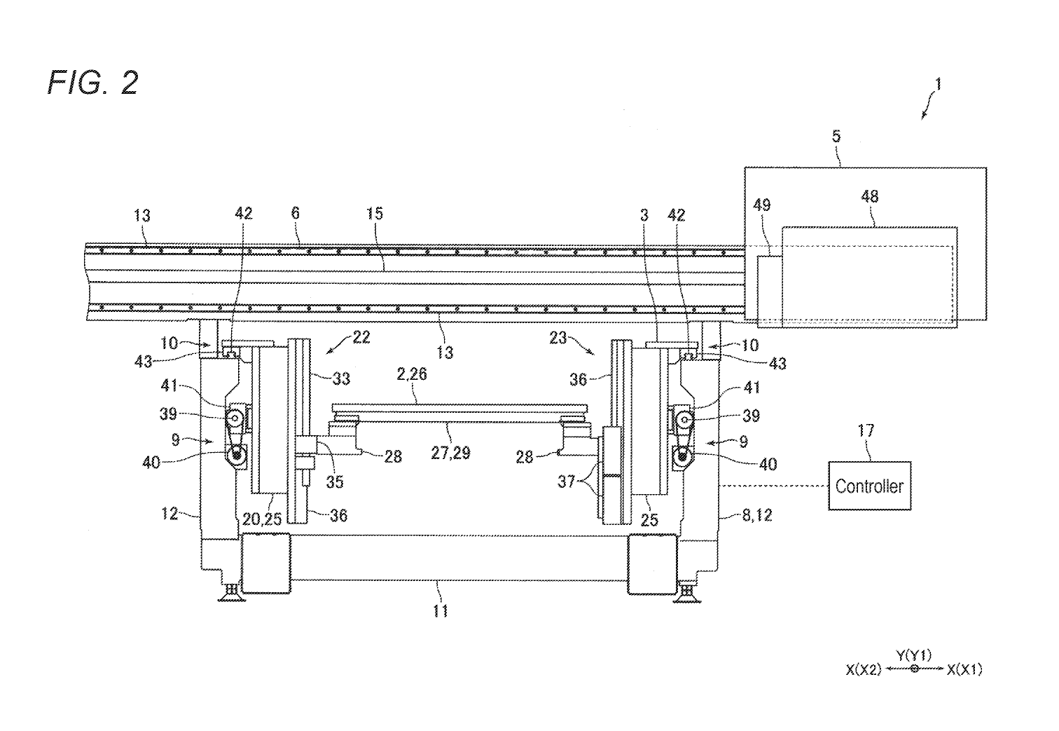

FIG. 1 is a perspective view of a printer 1 according to an embodiment of this disclosure. FIG. 2 is a schematic front view of the printer 1 illustrated in FIG. 1.

The printer 1 according to this embodiment is an inkjet printer for industrial use to manufacture printed matters. A specific example of the printer 1 according to this embodiment may be a three-dimensional object manufacturing apparatus for use in manufacturing, as the printed matter, three-dimensional objects. The printer 1 according to this embodiment may be hereinafter referred to as “three-dimensional object manufacturing apparatus 1”. The three-dimensional object manufacturing apparatus 1 has a stage 3 with a table 2 on which a three-dimensional object is formable, and a carriage 5 mounted with inkjet heads 51 to 58, described later, from which ink droplets are ejected toward the table 2.

The three-dimensional object manufacturing apparatus 1 further has a suspending frame 6 that holds the carriage 5 in a manner that the carriage 5 is movable in a main scanning direction orthogonal to the vertical direction, a carriage driving mechanism 7 that drives the carriage 5 to move on the suspending frame 6 in the main scanning direction, a body frame 8 that holds the stage 3 in a manner that the stage 3 is movable in a sub scanning direction orthogonal to the main scanning direction, stage driving mechanisms 9 that drive the stage 3 to move in the sub scanning direction relative to the body frame 8, and guiding mechanisms 10 that guide the stage 3 in the sub scanning direction. The three-dimensional object manufacturing apparatus 1 has a cabinet (not illustrated in the drawings) in which these structural elements are housed. The three-dimensional object manufacturing apparatus 1 further has a controller 17 programmed to control the three-dimensional object manufacturing apparatus 1.

In the description given below, “left-right direction” refers to the main scanning direction (X direction in FIG. 1), and “front-rear direction” refers to the sub scanning direction (Y direction in FIG. 1). Further, “front” side refers to one of directions included in the front-rear direction (Y1 direction), “rear” side refers to the other direction included in the front-rear direction (Y2 direction), “right” side refers to one of directions included in the left-right direction (X1 direction), and “left” side refers to the other direction included in the left-right direction (X2 direction).

The body frame 8 has a bottom member 1 and two side members 12 rising upward from left and right ends of the bottom member 11. The suspending frame 6 has a thin and long cuboidal shape with its longitudinal axis extending in the left-right direction. The suspending frame 6 is secured to the side members 12. The suspending frame 6 is disposed above rear end parts of the side members 12. The carriage 5 supported by the suspending frame 6 is disposed above the stage 3, i.e., above the table 2.

To the front surface of the suspending frame 6 are secured two guide rails 13 that guide the carriage 5 in the left-right direction. The guide rails 13 are secured to the suspending frame 6, so that the longitudinal direction of each guide rail 13 is coincident with the left-right direction. The two guide rails 13 secured to the suspending frame 6 are spaced apart at a predetermined interval in the vertical direction. A guide block (not illustrated in the drawings) engageable with the guide rails 13 is secured to the carriage 5.

As illustrated in FIG. 1, the carriage driving mechanism 7 has two pulleys 14, a belt 15 hung across the pulleys 14, and a motor 16 that rotates the pulleys 14. The two pulleys 14 are fitted to the suspending frame 6 so as to rotate around a rotating axis extending in the vertical direction. The two pulleys 14 are respectively attached to left and right ends of the suspending frame 6. The belt 15 is partly secured to the carriage 5. The motor 16 is attached to the right end side of the suspending frame 6. The motor 16 is coupled to the pulley 14 attached to the right end of the suspending frame 6 with a predetermined power transmitting mechanism interposed therebetween. By driving the motor 16, the carriage 5 is moved in the left-right direction along the guide rails 13.

[Stage]

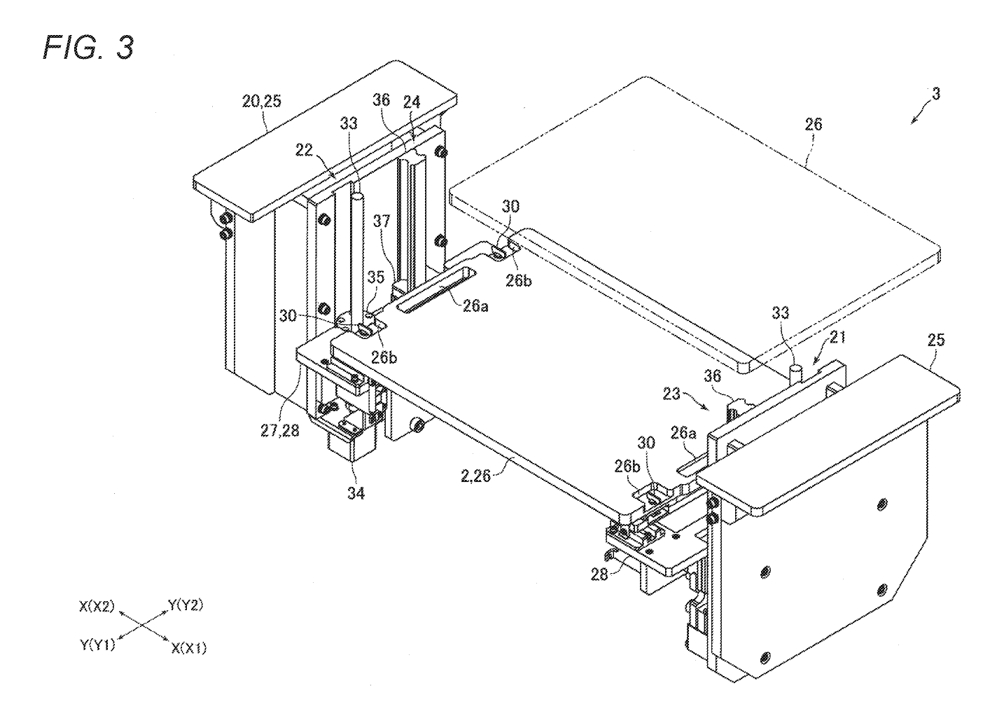

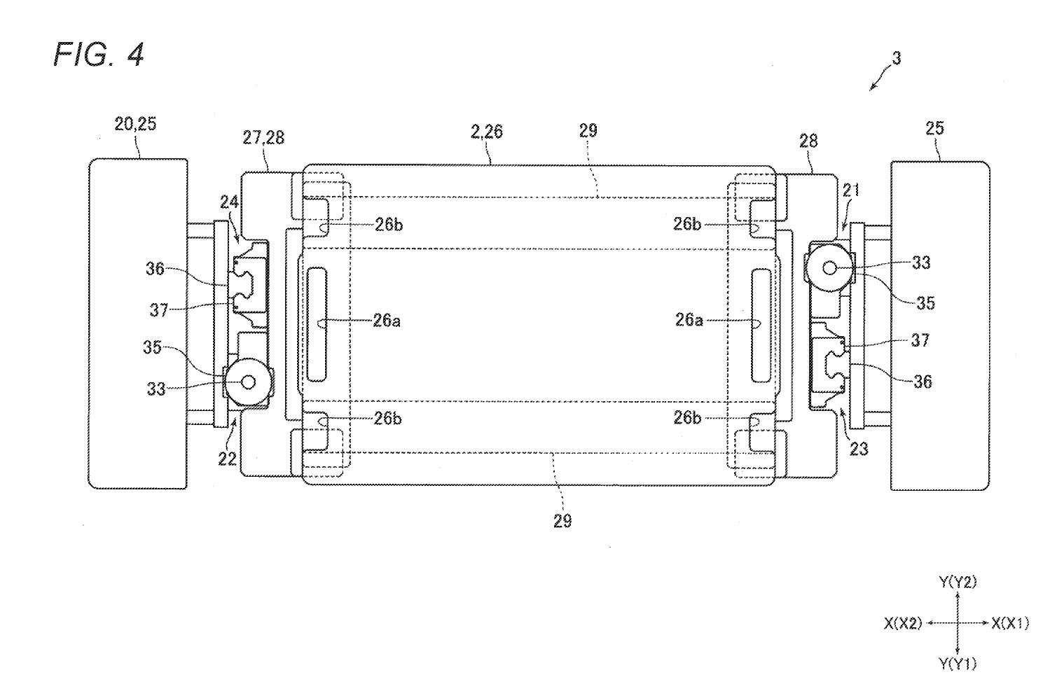

FIG. 3 is a perspective view of the stage 3 illustrated in FIG. 1. FIG. 4 is a schematic plan view of the stage 3 illustrated in FIG. 1.

The stage 3 is disposed at a position above the bottom member 11 and between the two side members 12 in the left-right direction. The stage 3 has, in addition to the table 2, a stage frame 20; an example of the table support, two lifting mechanisms 21 and 22, and two guiding mechanisms 23 and 24. The stage frame 20 supports the table 2 in a manner that the table 2 is movable upward and downward. The lifting mechanisms 21 and 22 move the table 2 upward and downward relative to the stage frame 20. The guiding mechanisms 23 and 24 guide the table 2 in the vertical direction. In this embodiment, the lifting mechanism 21 is an example of the first lifting mechanism, the lifting mechanism 22 is an example of the second lifting mechanism, the guide mechanism 23 is an example of the first guiding mechanism, and the guiding mechanism 24 is an example of the second guiding mechanism.

The stage frame 20 has two side members 25 constituting left and right side parts of the stage frame 20. The two side members 25 are coupled with a coupling member not illustrated in the drawings. The table 2 is disposed between the two side members 25 in the left-right direction. The table 2 has an object-shaping table 26 having a flat rectangular shape, and an object-shaping table holder 27. The object-shaping table holder 27 supports the object-shaping table 26 and is supported by the stage frame 20 so as to move upward and downward. The object-shaping table 26 is detachably attached to the object-shaping table holder 27. The object-shaping table holder 27 has two side members 28 constituting left and right end parts of the table 2, and two coupling member 29 by which the two side members 28 are coupled with each other (see FIG. 4).

The upper surface of the object-shaping table 26 is a flat surface approximately orthogonal to the vertical direction. The three-dimensional object is formed on the upper surface of the object-shaping table 26. The object-shaping table 26 is positioned so that, among four end surfaces of its rectangular shape, two end surfaces parallel to each other are parallel to the front-rear direction and the other two end surfaces parallel to each other are parallel to the left-right direction. The object-shaping table 26 is made of an aluminum alloy, and its upper surface has been subjected to an aluminum anodizing process. On the upper surfaces of the side members 28 are formed mounting planes that are orthogonal to the vertical direction. The left end part and the right end parts of the object-shaping table 26 are mounted on these mounting planes.

The object-shaping table 26 mounted on the mounting planes are secured to the object-shaping table holder 27 with screws 30 (see FIG. 3). The screws 30 are fitted in, for example, left, right, front, and rear end parts of the object-shaping table 26. The object-shaping table 26, when pulled upward after the screws 30 are removed, is allowed to disengage from the object-shaping table holder 27, as illustrated with a two-dot chain line in FIG. 3. The object-shaping table 26 has through cavities 26a formed at its left and right ends. These cavities are used to grip the object-shaping table 26 when removed from the object-shaping table holder 27. At left and right ends on the upper surface of the object-shaping table 26, recesses 26b are formed to receive heads of the screws 30. The screws 30 are not shown in FIG. 4.

The lifting mechanisms 21 and 22 each have a lead screw 33 rotatably held by the stage frame 20, a motor 34 (see FIG. 3) that rotates the lead screw 33, and a nut member 35 attached to the table 2 and engageable with the lead screw 33. The two lifting mechanisms 21 and 22 can be independently driven. The guiding mechanisms 23 and 24 each have a guide rail 36 attached to the stage frame 20, and a guide block 37 attached to the table 2 and engageable with the guide rail 36. The guiding mechanisms 23 and 24 according to this embodiment may be LM guides (registered trademark) with ball retainers embedded in the guide blocks 37.

As illustrated in FIG. 4, the lifting mechanism 21 and the guiding mechanism 23 are disposed at positions on the right end side of the table 2 and are arranged in an aligned manner in the front-rear direction. Further, the lifting mechanism 21 and the guiding mechanism 23 are adjacently disposed at positions in vicinity to or at center of the table 2 in the front-rear direction. In this embodiment, the lifting mechanism 21 is disposed at a position more rearward than the guiding mechanism 23. The lifting mechanism 22 and the guiding mechanism 24 are disposed at positions on the left end side of the table 2 and are arranged in an aligned manner in the front-rear direction. Further, the lifting mechanism 22 and the guiding mechanism 24 are adjacently disposed at positions in vicinity to or at center of the table 2 in the front-rear direction. In this embodiment, the guiding mechanism 24 is disposed at a position more rearward than the lifting mechanism 22.

A distance in the front-rear direction between the lifting mechanism 21 and the guiding mechanism 23 is equal to a distance in the front-rear direction between the lifting mechanism 22 and the guiding mechanism 24. Specifically, a distance in the front-rear direction between the center of the lead screw 33 of the lifting mechanism 21 and the center of the guide rail 36 of the guiding mechanism 23 is equal to a distance in the front-rear direction between the center of the lead screw 33 of the lifting mechanism 22 and the center of the guide rail 36 of the guiding mechanism 24.

The lifting mechanism 21 is disposed at a position slightly more rearward than the guiding mechanism 24 in the front-rear direction. The guiding mechanism 23 is disposed at a position slightly more rearward than the lifting mechanism 22 in the front-rear direction. In this embodiment, the left-right direction (X direction) is the first direction orthogonal to the vertical direction, and the front-rear direction (Y direction) is the second direction orthogonal to the vertical direction and the first direction. In this embodiment, the main scanning direction is the first direction, and the sub scanning direction is the second direction. In this embodiment, the rearward (Y2 direction) is the third direction; one of directions included in the second direction.

The lead screws 33 are rotatably supported by inner surfaces of the two side members 25 in the left-right direction, so that axial directions of the lead screws 33 are coincident with the vertical direction. The motors 34 are secured to lower end sides of the two side members 25. The output shafts of the motors 34 are coupled to lower end parts of the lead screws 33. The nut members 35 are attached to outer surfaces of the two side members 28 in the left-right direction. The guide rails 36 are secured to inner surfaces of the two side members 25 in the left-right direction, so that the longitudinal direction of each guide rail 36 is coincident with the vertical direction. The guide blocks 37 are attached to outer surfaces of the two side members 28 in the left-right direction.

[Stage Driving Mechanism and Guiding Mechanism]

The stage driving mechanisms 9 and the guiding mechanisms 10 are disposed on both sides of the stage 3 in the left-right direction. The stage driving mechanisms 9 each have a lead screw 39 rotatably attached to the side member 12, a motor 40 that rotates the lead screw 39, and a nut member 41 attached to the stage 3 and engageable with the lead screw 39. The guiding mechanisms 10 each have a guide rail 42 attached to the side member 12, and a guide block 43 attached to the stage 3 and engageable with the guide rail 42.

The lead screws 39 are rotatably supported by inner surfaces of the two side members 12 in the left-right direction, so that axial directions of the lead screws 39 are coincident with the front-rear direction. The motors 40 are secured to inner surfaces of the two side members 12 in the left-right direction. The motors 40 are secured to front end parts of the side members 12. The output shafts of the motors 40 are coupled to front end parts of the lead screws 39 with the use of pulleys and belts. The nut members 41 are attached to outer surfaces of the two side members 25 in the left-right direction. With the nut members 41 being attached to the stage frame 20, the stage driving mechanisms 9 move the stage frame 20 in the front-rear direction.

The guide rails 42 are secured to upper end surfaces of the side members 12, so that the longitudinal direction of each guide rail 42 is coincident with the front-rear direction. The guide blocks 43 are secured to upper end sides of the side members 25 in the stage frame 20. These guide blocks 43 are each engaged with the guide rail 42 from its upper side.

In this embodiment, the stage 3 is allowed to move forward to a position at which the whole stage 3 is ahead of the carriage 5, as illustrated in FIG. 1, meaning that the table 2 is allowed to move forward to a position at which the table 2 is ahead of the carriage 5. The stage driving mechanisms 9 move the table 2 in the front-rear direction at the time of forming a three-dimensional object, and move the table 2 to the front end of the three-dimensional object manufacturing apparatus 1 at the time of removing the completed three-dimensional object from the apparatus 1. When the completed three-dimensional object is removed from the three-dimensional object manufacturing apparatus 1, the stage driving mechanisms 9 move the table 2 so as to stick out of the apparatus 1. The cabinet of the three-dimensional object manufacturing apparatus 1 has an opening through which the completed three-dimensional object is removable.

[Carriage]

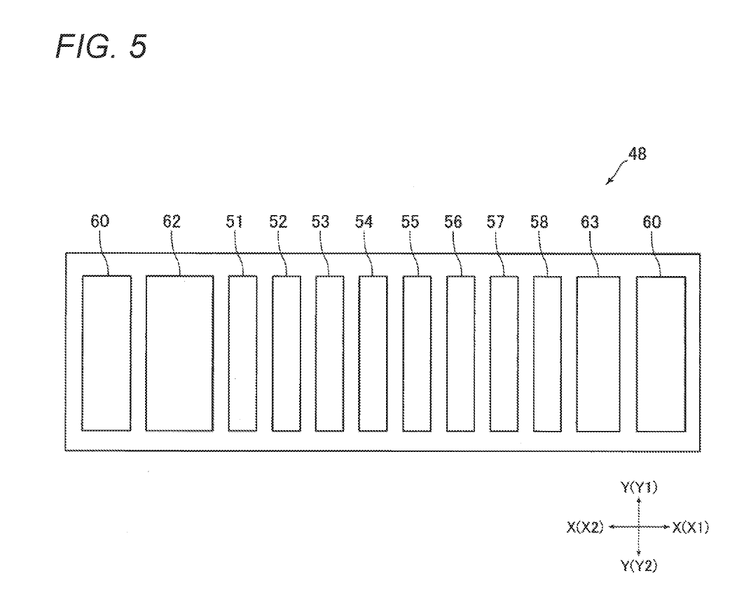

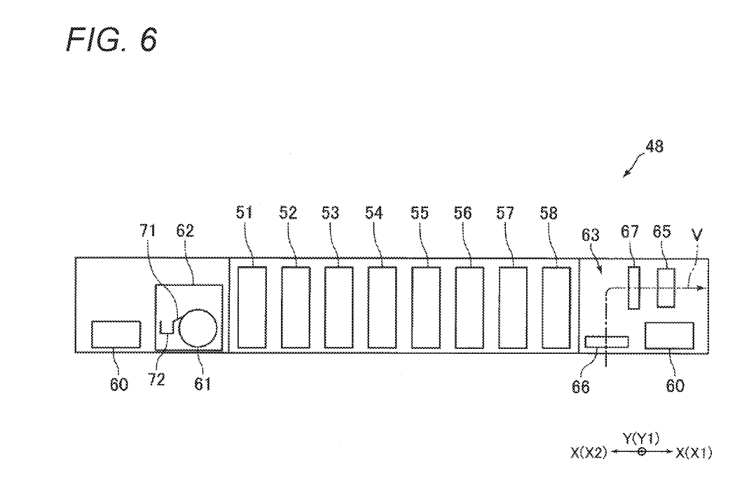

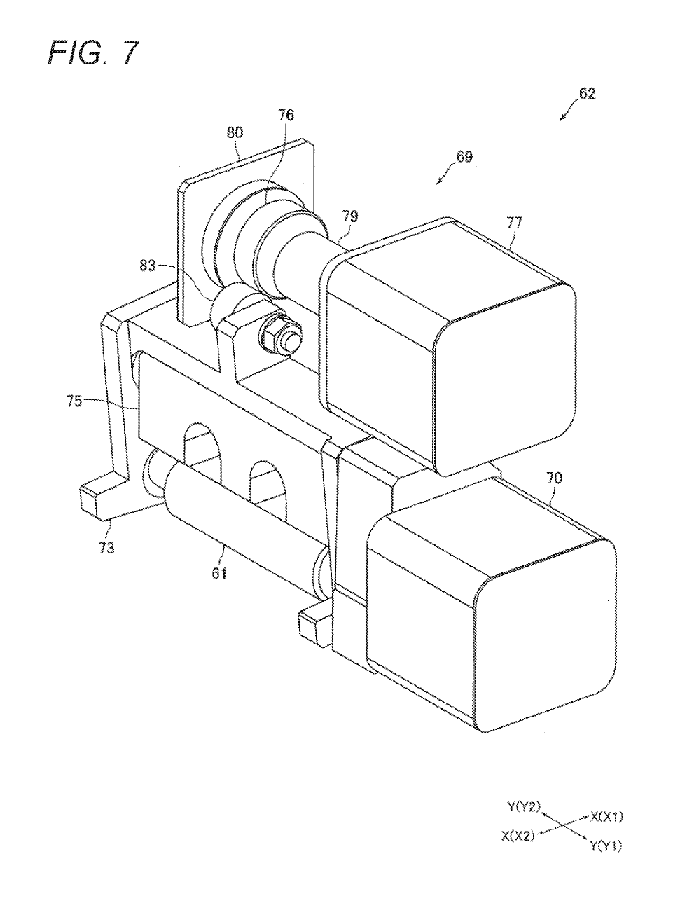

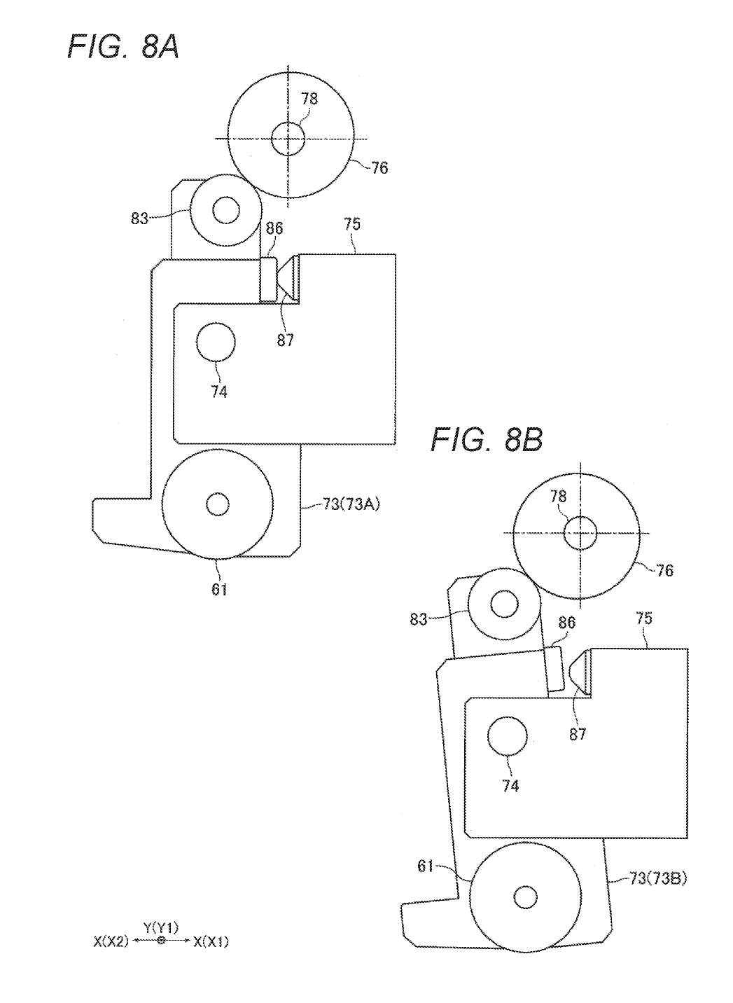

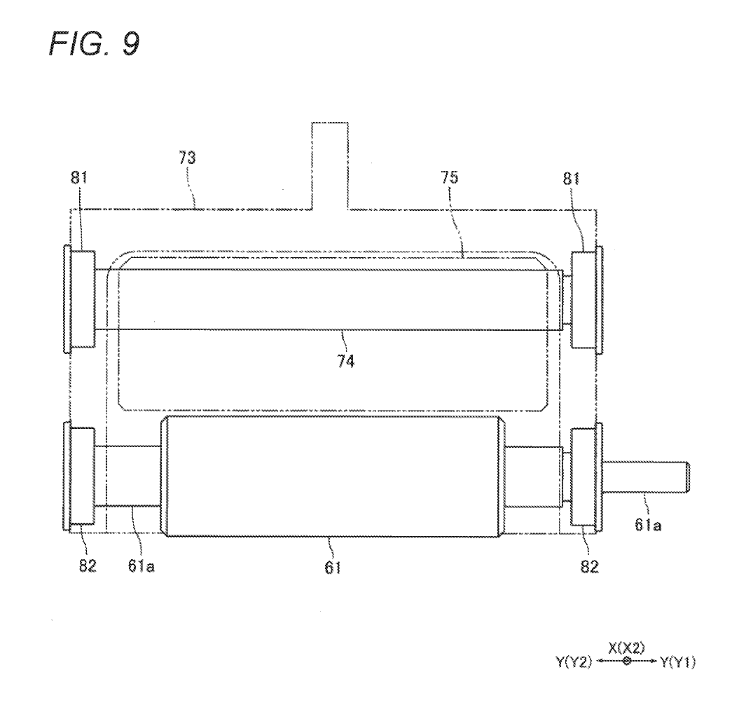

FIG. 5 is a bottom view, illustrating a eject unit 48 mounted in the carriage 5 illustrated in FIG. 1. FIG. 6 is a front view, illustrating the eject unit 48 illustrated in FIG. 5. FIG. 7 is a perspective view in part of a flattening roller unit 62 illustrated in FIG. 5. FIGS. 8A and 8B are front views, illustrating the flattening roller unit 62 illustrated in FIG. 7 and its operation. FIG. 9 is a side view, illustrating supports of a flattening roller 61 and supports of a roller holding member 73 illustrated in FIG. 7.

The carriage 5 is mounted with the eject unit 48 used to form a three-dimensional object. The carriage 5 is further mounted with a laser telemeter 49 (see FIG. 2). The eject unit 48 has a plurality of inkjet heads 51 to 58 from which ink droplets are ejected toward the table 2. In this embodiment, the eject unit 48 has eight inkjet heads 51 to 58. The inkjet heads 51 to 58 are disposed, so that the ink droplets ejected are directed downward. The inkjet heads 51 to 58 eject ultraviolet-curable inks.

The eject unit 48 further has ultraviolet irradiators 60 that radiate ultraviolet light to cure the ultraviolet-curable inks ejected from the inkjet heads 51 to 58 toward the table 2. In this embodiment, the eject unit 48 has two ultraviolet irradiators 60. The eject unit 48 has a flattening roller unit 62 and an ink mist adsorbing mechanism 63. The flattening roller unit 62 has a flattening roller 61 that flattens surfaces (upper surfaces) of ink droplets ejected from the inkjet heads 51 to 58 toward the table 2. The ink mist adsorbing mechanism 63 adsorbs ink mist generated when the inks are ejected from the inkjet heads 51 to 58.

The carriage 5 is mounted with these structural elements of the eject unit 48; eight inkjet heads 51 to 58, two ultraviolet irradiators 60, flattening roller unit 62, and ink mist adsorbing mechanism 63. In the carriage 5 are mounted, from left to right in the mentioned order, ultraviolet irradiator 60, flattening roller unit 62, inkjet head 51, inkjet head 52, inkjet head 53, inkjet head 54, inkjet head 55, inkjet head 56, inkjet head 57, inkjet head 58, and ultraviolet irradiator 60. The ink mist adsorbing mechanism 63 is disposed at a position above the rightmost ultraviolet irradiator 60 and between the rightmost ultraviolet irradiator 60 and the inkjet head 58.

The inkjet heads 51 and 58 are support material heads from which inks (support materials) for supporting a three-dimensional object are ejected. The inkjet head 52 is a modeling material head from which a modeling ink (modeling material) is ejected. The inkjet head 53 is a clear ink head from which a transparent ink (clear ink) is ejected. The inkjet heads 54 to 57 are color ink heads from which color inks are ejected. In this embodiment, the inkjet head 54 ejects a yellow ink, the inkjet head 55 ejects a cyan ink, the inkjet head 56 ejects a magenta ink, and the inkjet head 57 ejects a black ink.

Examples of the ultraviolet irradiators 60 may include UVLED, metal halide lamp, and mercury lamp. The ultraviolet irradiators 60 radiate ultraviolet light downward. The ultraviolet irradiators 60 in this embodiment are UVLEDs.

The ink mist adsorbing mechanism 63 has a suctioning fan 65 that suctions the ink mist, and two filters 66 and 67 that are disposed at positions on the path of the ink mist to be suctioned by the suctioning fan 65 (see FIG. 6). The suctioning fan 65 is disposed above the rightmost ultraviolet irradiator 60. The filter 66 is disposed between the rightmost ultraviolet irradiator 60 and the inkjet head 58. The filter 67 is disposed on the left of the suctioning fan 65. An inlet for air including the ink mist is formed below the filter 66. An air outlet is formed on the right of the suctioning fan 65. When the suctioning fan 65 is driven in the ink mist adsorbing mechanism 63, air including the ink mist suctioned through the inlet below the filter 66 travels through the filter 66 and then the filter 67, and is ejected out of the outlet on the right of the suctioning fan 65, as illustrated with arrow V in FIG. 6.

The flattening roller unit 62 has a roller lifting mechanism 69 that moves the roller 61 upward and downward relative to the carriage 5 (see FIG. 7), and a motor 70 that rotates the flattening roller 61. The flattening roller unit 62 further has a blade 71 and an ink collecting unit 72 (see FIG. 6). The blade 71 is used to remove any ink adhered to the flattening roller 61 when flattening surfaces of the ejected ink droplets on the table 2. The ink collecting unit 72 is used to collect the ink removed by the blade 71 from the surface of the flattening roller 61.

The roller lifting mechanism 69 is mounted in the carriage 5. The roller lifting mechanism 69 has a roller holding member 73, a support shaft 74, a holding frame 75, an eccentric cam 76, and a motor 77. The roller holding member 73 rotatably holds the flattening roller 61. The support shaft 74 supports the roller holding member 73 in an oscillatable manner. The holding frame 75 holds the support shaft 74. The eccentric cam 76 oscillates the roller holding member 73 relative to the holding frame 75. The motor 77 rotates the eccentric cam 76. The roller lifting mechanism 69 further has a rotating shaft 78 (see FIGS. 8A and 8B) to which the eccentric cam 76 is fixable. The holding frame 75 and the motor 77 are secured to the carriage 5.

The rotating shaft 78 is disposed so as to have its axial direction coincide with the front-rear direction. One end (front end) of the rotating shaft 78 is coupled to the output shaft of the motor 77 with the use of a coupling 79 (see FIG. 7). The other end (rear end) of the rotating shaft 78 is rotatably supported by a support member 80. The support member 80 is secured to the holding frame 75. The eccentric cam 76 has a disc-like-shape. The eccentric cam 76 is secured to the rotating shaft 78 with its axial center being displaced from the axial center of the rotating shaft 78.

The support shaft 74 is disposed so as to have its axial direction coincide with the front-rear direction. The support shaft 74 is secured to the holding frame 75. Both ends of the support shaft 74 are projecting more outward in the front-rear direction than the holding frame 75. As illustrated in FIG. 9, two bearings 81 are attached to the roller holding member 73 to support both ends of the support shaft 74. These bearings 81 allow the roller holding member 73 to oscillate relative to the holding frame 75 around an axis extending in the front-rear direction. The bearings 81 are roller bearings.

The flattening roller 61 is disposed so as to have its axial direction coincide with the front-rear direction. The flattening roller 61 is disposed below the support shaft 74. As described earlier, the flattening roller unit 62 is disposed on the right of the leftmost ultraviolet irradiator 60 of the eject unit 48. The flattening roller 61 is adjacent in the left-right direction to the leftmost ultraviolet irradiator 60 of the eject unit 48. In the carriage 5, the leftmost ultraviolet irradiator 60 of the eject unit 48 is mounted in the carriage 5 in adjacency to the flattening roller 61 in the left-right direction.

As illustrated in FIG. 9, two bearings 82 are attached to the roller holding member 73. Supports 61a formed at both ends of the flattening roller 61 are supported by these bearings 82. The bearings 82 allow the flattening roller 61 to rotate relative to the roller holding member 73 around a rotating axis extending in the front-rear direction. The bearings 82 are roller bearings. The motor 70, blade 71, and ink collecting unit 72 are secured to the roller holding member 73 and are allowed to oscillate with the flattening roller 61 and the roller holding member 73 relative to the holding frame 75. The output shaft of the motor 70 is coupled to the flattening roller 61 with the use of a gear not illustrated in the drawings.

A cam follower 83 that makes contact with the eccentric cam 76, which in the form of a roller, is rotatably attached to the upper end side of the roller holding member 73. The cam follower 83 is attached to the roller holding member 73 so as to rotate around a rotating axis extending in the front-rear direction. The cam follower 83 is disposed above the support shaft 74, specifically, at a position approximately right above the support shaft 74. The cam follower 83 is disposed at a position below and to the left of the eccentric cam 76 in contact with a lower left part of the eccentric cam 76. To make the cam follower 83 contact the eccentric cam 76, the roller holding member 73, centering on the support shaft 74, is biased clockwise in FIGS. 8A and 8B by a spring member not illustrated in the drawings.

When the eccentric cam 76 rotates, the roller holding member 73, centering on the support shaft 74, oscillates to and from a contact position (position in FIG. 8A) 73A and a retreat position (position in FIG. 8B) 73B. At the contact position 73A, the flattening roller 61 is allowed to contact surfaces (upper surfaces) of the ink droplets. At the retreat position 73B, the flattening roller 61 retreats to a position above the ink droplet surfaces. Thus, the eccentric cam 76 prompts the roller holding member 73 to oscillate to and from the contact position 73A and the retreat position 73B. An amount of vertical movement of the flattening roller 61 (difference between heights of the flattening roller 61 when the roller holding member 73 is at the contact position 73A and at the retreat position 73B) may be approximately 0.1 mm to 0.3 mm. When the roller holding member 73 is at the contact position 73A, the flattening roller 61 is right below the support shaft 74.

In this embodiment, when the eccentric cam 76 rotates, the roller holding member 73 at the retreat position 73B moves downward and to the left toward the contact position 73A. When the eccentric cam 76 rotates, the roller holding member 73 at the contact position 73A moves upward and to the right toward the retreat position 73B. The flattening roller 61 is disposed on the right of the leftmost ultraviolet irradiator 60 of the eject unit 48. When the roller holding member 73 moves from the contact position 73A to the retreat position 73B, the flattening roller 61 moves away from the leftmost ultraviolet irradiator 60 of the eject unit 48. When the roller holding member 73 is at the retreat position 73B, the flattening roller 61 is at a position further away from the leftmost ultraviolet irradiator 60 of the eject unit 48 than when the roller holding member 73 is at the contact position 73A.

As illustrated in FIGS. 8A and 8B, the roller lifting mechanism 69 has stopper members 86 and 87 that position the roller holding member 73 at the contact position 73A. The stopper members 86 and 87 are disposed above the support shaft 74. Specifically, the stopper members 86 and 87 are disposed at positions above and to the right of the support shaft 74 and below the cam follower 83. The stopper member 86 is secured to the roller holding member 73, while the stopper member 87 is secured to the holding frame 75. The stopper member 86 is disposed on the left of the stopper member 87. When the roller holding member 73 is at the contact position 73A, the stopper member 86 contacts the stopper member 87 from its left side.

The laser telemeter 49 is disposed at a position adjacent to the eject unit 48 in the left-right direction. The laser telemeter 49 radiates laser light downward. The laser telemeter 49 is configured to measure a distance in the vertical direction between the laser telemeter 49 and the upper surface of the table 2, i.e., the upper surface of the object-shaping table 26. The laser telemeter 49 further measures distances in the vertical direction between the laser telemeter 49 and different positions on the upper surface of a three-dimensional object currently formed to detect the current shape of the three-dimensional object.

In this embodiment, the carriage 5 moves in the left-right direction and the table 2 moves in the front-rear direction before a three-dimensional object starts to be formed, and the laser telemeter 49 measures distances in the vertical direction between the laser telemeter 49 and different positions on the upper surface of the table 2. For example, the laser telemeter 49 may measure distances in the vertical direction between the laser telemeter 49 and four positions on the upper surface of the table 2. The lifting mechanism 21, 22 moves the table 2 upward or downward based on a result of measurement obtained by the laser telemeter 49 to set the initial height of the upper surface of the table 2 (i.e., height of the upper surface of the object-shaping table 26) when the three-dimensional object starts to be formed. Specifically, the lifting mechanism 21, 22 moves the table 2 upward or downward, so that a position on the upper surface of the table 2 closest to the laser telemeter 49 (highest position on the upper surface of the table 2) is slightly below the lower end of the flattening roller 61 when the roller holding member 73 is at the contact position 73A to set the initial height of the upper surface of the table 2 when the three-dimensional object starts to be formed.

In this embodiment, during a process to form a three-dimensional object, the controller 17 of the three-dimensional object manufacturing apparatus 1 compares the shape of the currently formed three-dimensional object known from the result of measurement by the laser telemeter 49 to the design data of the three-dimensional object. When the ongoing three-dimensional object is formed as planned by the design data, the controller 17 prompts the three-dimensional object manufacturing apparatus 1 to continue to form the three-dimensional object. Otherwise, the controller 17 suspends the operation of the three-dimensional object manufacturing apparatus 1.

The carriage 5 moves in the left-right direction along the guide rails 13. In this embodiment, the position of the carriage 5 at right ends of the guide rails 13 is the home position of the carriage 5. To form a three-dimensional object using the three-dimensional object manufacturing apparatus 1, the carriage 5 moves to the left from the home position, and the inkjet heads 51 to 58 eject the ink droplets. At the time, the roller holding member 73 is at the retreat position 73B.

When the carriage 5 that has moved to the left end side returns to the right, the roller holding member 73 moves to the contact position 73A. Then, the flattening roller 61 flattens the ink droplet surfaces. When the carriage 5 moves rightward, the roller holding member 73 is at the contact position 73A. At the time of flattening the ink droplet surfaces, the flattening roller 61 rotates counterclockwise in FIGS. 6 and 8. The flattening roller unit 62 may be equipped with a locking mechanism for locking the flattening roller 61 when the carriage 5 is at the home position.

[Ink Circulating Mechanism and Ink Collecting Mechanism]

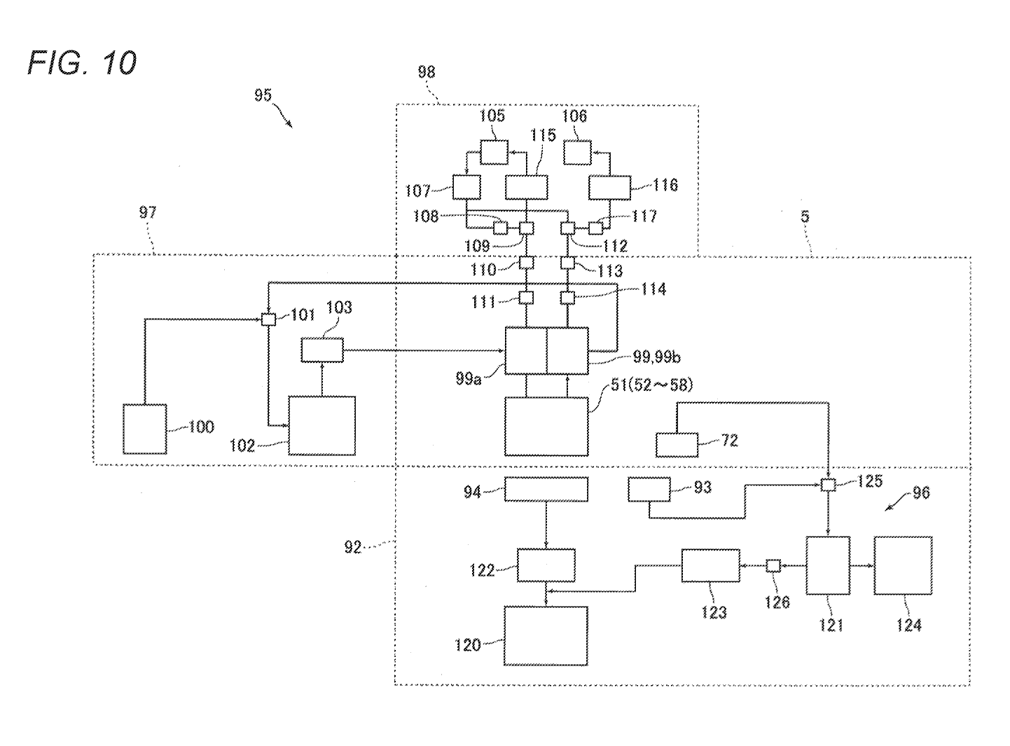

FIG. 10 is a block diagram, illustrating an ink circulating mechanism 95 and an ink collecting mechanism 96 of the three-dimensional object manufacturing apparatus 1 illustrated in FIG. 1.

The three-dimensional object manufacturing apparatus 1 is equipped with a maintenance unit 92 that prevents nozzles of the inkjet heads 51 to 58 from being clogged with inks. The maintenance unit 92 has a wiper, an ink collecting unit 93, and a cap 94. The wiper is used to wipe off any ink adhered to nozzle surfaces of the inkjet heads 51 to 58. The ink collecting unit 93 is used to collect the ink wiped off by the wiper. The cap 94 has a suctioning mechanism that suctions any ink left in nozzles of the inkjet heads 51 to 58. The maintenance unit 92 may be disposed below the carriage 5 at the home position. The suctioning mechanism of the cap 94 may be dispensable, in which case the ink droplets are ejected toward the cap 94 from the inkjet heads 51 to 58 during maintenance of these inkjet heads.

The three-dimensional object manufacturing apparatus 1 according to this embodiment has an ink circulating mechanism 95, and an ink collecting mechanism 96. The ink circulating mechanism 95 is used to circulate the inks inside the inkjet heads 51 to 58. The ink collecting mechanism 96 is used to collect the inks collected by the ink collecting units 72 and 93 and suctioned by the cap 94.

The ink circulating mechanism 95 has an ink feeder 97, an air controller 98, and sub tanks 99. The ink feeder 97 feeds the inkjet heads 51 to 58 with inks. The air controller 98 controls a pneumatic pressure for circulation of the inks. The sub tanks 99 are mounted in the carriage 5. The sub tanks 99 are each coupled to a respective one of the eight inkjet heads 51 to 58. Thus, the ink circulating mechanism 95 has eight sub tanks 99. The sub tanks 99 each have an upstream liquid chamber 99a and a downstream liquid chamber 99b. The outlets of the liquid chambers 99a are coupled to the inlets of the inkjet heads 51 to 58. The inlets of the liquid chambers 99b are coupled to the outlets of the inkjet heads 51 to 58.

The ink feeder 97 has ink tanks 100. The ink tank 100 is coupled to the inlet of an ink pump 102 through a valve 101. The outlet of the ink pump 102 is coupled to the inlet of the liquid chamber 99a with a filter 103 interposed therebetween. The outlet of the liquid chamber 99b is coupled to the valve 101. The ink tanks 100 for the inkjet heads 54 to 57 (color ink tanks) have a capacity smaller than the capacity of the ink tanks 100 for the inkjet heads 51 to 53 and 58 (support ink tank, modeling ink tank, and clear ink tank). The ink tanks 100 for the inkjet heads 54 to 57 have the capacity of 1 liter, and the ink tank 100 for the inkjet heads 51 to 53 and 58 have the capacity of 3.5 liters.

The air controller 98 has an upstream pressure pump 105, and a downstream pressure pump 106. The outlet of the pressure pump 105 is coupled to the liquid chamber 99a through an air chamber 107, valves 108 to 110, and a filter 111. The eject port of the pressure pump 105 is coupled to the liquid chamber 99b through the air chamber 107, valves 112 and 113, and a filter 114. An air chamber 115 is coupled to the suction port of the pressure pump 105 and to the valve 109. An air chamber 116 is coupled to the suction port of the pressure pump 106 and to the valve 112 through a valve 117. Air flow paths between the pressure pump 105 and the valves 108 and 112 have positive pressures, while air flow paths between the pressure pump 105 and the valve 109 and between the pressure pump 106 and the valve 117 have negative pressures.

The ink collecting mechanism 96 has a waste liquid tank 120, a waste liquid buffer 121, liquid feed pumps 122 and 123, and a vacuum pump 124. The suctioning port of the liquid feed pump 122 is coupled to the cap 94. The waste liquid tank 120 is coupled to the eject port of the liquid feed pump 122. The waste liquid buffer 121 is coupled to the ink collecting units 72 and 93 through a valve 125. The suctioning port of the liquid feed pump 123 is coupled to the waste liquid buffer 121 through a valve 126. The waste liquid tank 120 is coupled to the eject port of the liquid feed pump 123. The vacuum pump 124 is coupled to the waste liquid buffer 121.

### Major Effects of this Embodiment

In this embodiment, the lifting mechanism 21 and the guiding mechanism 23 are arranged at positions on the right end side of the table 2 in an aligned manner in the front-rear direction, and the lifting mechanism 22 and the guiding mechanism 24 are arranged at positions on the left end side of the table 2 in an aligned manner in the front-rear direction. In this embodiment, the lifting mechanism 21 is disposed at a position more rearward than the guiding mechanism 23, and the guiding mechanism 24 is disposed at a position more rearward than the lifting mechanism 22. In the printer disclosed herein, two lifting mechanisms 21 and 22 and two guiding mechanisms 23 and 24 are respectively arranged so as to diagonally face each other. This structural feature may allow for balanced movements of the table 2 in the vertical direction without inclining the upper surface of the table 2 moved upward or downward. This embodiment may achieve an improved accuracy in vertically positioning the table 2 moved upward or downward. As a result, high precision may be achieved in manufacture of a three-dimensional object on the table 2.

This embodiment is particularly characterized in that the lifting mechanism 21 and the guiding mechanism 23 are adjacently arranged at positions in vicinity to or at center of the table 2 in the front-rear direction, the lifting mechanism 22 and the guiding mechanism 24 are adjacently arranged at positions in vicinity to or at center of the table 2 in the front-rear direction, and a distance in the front-rear direction between the lifting mechanism 21 and the guiding mechanism 23 is equal to a distance in the front-rear direction between the lifting mechanism 22 and the guiding mechanism 24. These structural features may allow for more balanced movements of the table 2 in the vertical direction without inclining the upper surface of the table 2 moved upward or downward. This embodiment thus further characterized may achieve a more improved accuracy in vertically positioning the table 2, allowing for even higher precision in manufacture of a three-dimensional object on the table 2.

### Another Embodiment

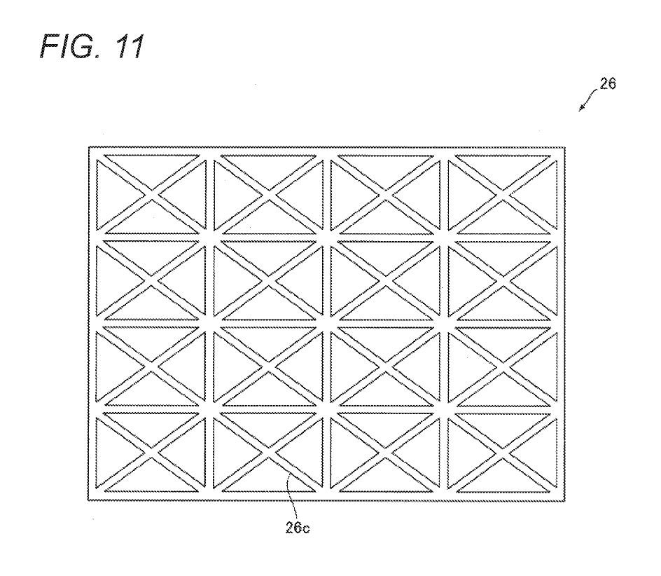

In the embodiment described earlier, a reinforcing rib 26c in a gridlike or honeycomb fashion may be formed on the lower surface (back surface) of the object-shaping table 26, as illustrated in FIG. 11. The reinforcing rib 26c may impart a required strength to the object-shaping table 26 even after any parts of this table but a rib-formed part are reduced in thickness. This may allow for weight reduction of the object-shaping table 26 without compromising the strength required of the object-shaping table 26. As a result, the object-shaping table 26 may be easily removable from the object-shaping table holder 27. In the earlier embodiment, the object-shaping table 26 is detachably attached to the object-shaping table holder 27. The object-shaping table 26 may be integral with the object-shaping table holder 27 or may be secured by welding to the object-shaping table holder 27.

While the object-shaping table 26 is secured to the object-shaping table holder 27 with screws 30 in the earlier embodiment, the object-shaping table 26 may not necessarily be secured to the object-shaping table holder 27. Instead, a plurality of positioning pins projecting upward may be formed on or secured to the mounting planes of the side members 28, and through holes for the positioning pins to be inserted may be formed on the object-shaping table 26. In this structure, the object-shaping table 26 is mounted on the mounting planes, with the positioning pins being inserted in the through holes. When a completed three-dimensional object is removed from the three-dimensional object manufacturing apparatus 1 thus structured, the three-dimensional object and the object-shaping table 26 may be altogether removed by detaching the object-shaping table 26 using a robot from the object-shaping table holder 27 of the table 2 moved to the front end of the apparatus. The robot may transport the object-shaping table 26 removed from the object-shaping table holder 27 (object-shaping table 26 having the three-dimensional object thereon) to a predetermined shelf. Then, the robot may transport the empty object-shaping table 26 from the shelf to the object-shaping table holder 27 and attaches the transported object-shaping table 26 to the object-shaping table holder 27.

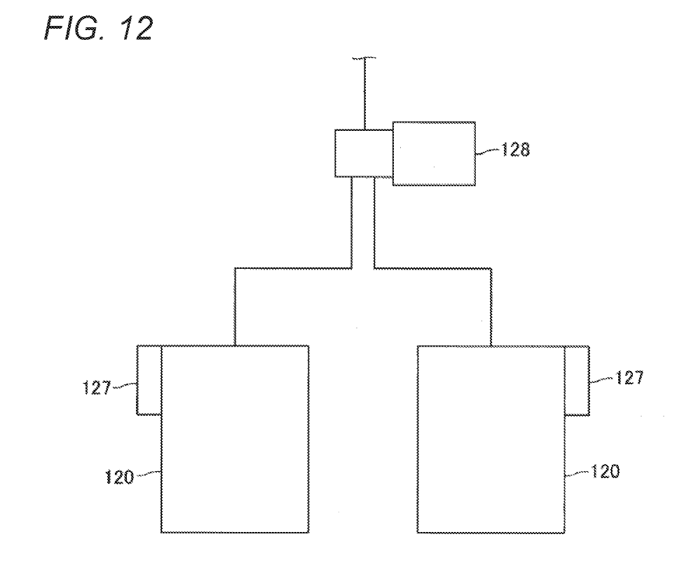

In the earlier embodiment, the ink collecting mechanism 96 may be equipped with a plurality of waste liquid tanks 120. As illustrated in FIG. 12, the ink collecting mechanism 96 may have two waste liquid tanks 120. In that case, an ink level detecting mechanism 127, such as a level meter that detects the ink level in the waste liquid tank 120, may be attached to each of the waste liquid tanks 120. A changeover valve 128 may be interposed between the two waste liquid tanks 120 and the liquid feed pumps 122 and 123. An example of the changeover valve 128 is an electromagnetic valve. A respective one of the two waste liquid tanks 120 is coupled to the changeover valve 128 through pipes.

One of the two waste liquid tanks 120 is coupled to the liquid feed pumps 122 and 123 through the changeover valve 128 so as to have the ink collected by the waste liquid tank 120 coupled to the liquid feed pumps 122 and 123. When the ink level detecting mechanism 127 of one of the waste liquid tanks 120 detects the ink level in this tank 120 is equal to a predetermined level, the changeover valve 128 changes an ink collecting path currently selected to another ink collecting path so as to have the ink collected by the other waste liquid tank 120. The changeover valve 128 changes one of the ink collecting paths to another, so that the other waste liquid tank 120 is coupled to the liquid feed pumps 122 and 123.

In case the ink collecting mechanism 96 has two waste liquid tanks 120, the changeover valve 128 changes one of the ink collecting paths to the other based on the result of detection by the ink level detecting mechanism 127 so as to have the ink collected by either one of the two waste liquid tanks 120. In case the ink collecting mechanism 96 has three or more waste liquid tanks 120, the changeover valve 128 changes one of the ink collecting paths to either one of the other paths based on the result of detection by the ink level detecting mechanism 127 so as to have the ink collected by one of the three or more waste liquid tanks 120.

In the earlier embodiment, a distance in the front-rear direction between the lifting mechanism 21 and the guiding mechanism 23 is equal to a distance in the front-rear direction between the lifting mechanism 22 and the guiding mechanism 24. Optionally, these distances may be set to differ from each other.

In the earlier embodiment, the lifting mechanism 21 and the guiding mechanism 23 are adjacently arranged at positions in vicinity to or at center of the table 2 in the front-rear direction. Optionally, the lifting mechanism 21 and the guiding mechanism 23 may be adjacently arranged at positions displaced from the center of the table 2 in the front-rear direction, or the lifting mechanism 21 may be disposed at a position on the rear end side of the table 2, and the guiding mechanism 23 may be disposed at a position on the front end side of the table 2. The lifting mechanism 21 and the guiding mechanism 23 may be located, so that these mechanisms are arranged in an aligned manner in a direction inclined relative to the front-rear direction when viewed in the vertical direction.

In the earlier embodiment, the lifting mechanism 22 and the guiding mechanism 24 are adjacently arranged at positions in vicinity to or at center of the table 2 in the front-rear direction. Optionally, the lifting mechanism 22 and the guiding mechanism 24 may be adjacently arranged at positions displaced from the center of the table 2 in the front-rear direction, or the lifting mechanism 22 may be disposed at a position on the front end side of the table 2, and the guiding mechanism 24 may be disposed at a position on the rear end side of the table 2. The lifting mechanism 22 and the guiding mechanism 24 may be located, so that these mechanisms are arranged in an aligned manner in a direction inclined relative to the front-rear direction when viewed in the vertical direction.

While the three-dimensional object manufacturing apparatus 1 forms a three-dimensional object on the table 2 in the earlier embodiment, the three-dimensional object manufacturing apparatus 1 may print an image or characters on a print object placed on the table 2. In the earlier embodiment, the stage 3 may have three or more lifting mechanisms to move the table 2 upward and downward. In the three-dimensional object manufacturing apparatus 1 thus structured, the laser telemeter 49 may measure vertical distances between the laser telemeter 49 and different positions on the upper surface of the table 2 before a three-dimensional object starts to be formed. Then, three or more lifting mechanisms may independently move the table 2 based on a result of measurement by the laser telemeter 49 to adjust any inclination of the upper surface of the table 2 (upper surface of the object-shaping table 26) relative to a horizontal plane.

While a three-dimensional object is formed by inkjet printing in the earlier embodiment, fused deposition modeling may be employed instead, in which a resin filament softened by heating and ejected from the eject unit 48 is used to form a three-dimensional object. In that case, the three-dimensional object manufacturing apparatus 1 may have a eject unit that ejects a resin filament softened by heating toward the table 2 to form a three-dimensional object.

What is claimed is:

1. A printer, comprising:
a table on which a printed matter is placeable;
a table support that supports the table in a manner that the table is movable upward and downward;
a first lifting mechanism and a second lifting mechanism that move the table upward and downward relative to the table support; and
a first guiding mechanism and a second guiding mechanism that guide the table in a vertical direction,
where a predetermined direction orthogonal to the vertical direction is defined as a first direction, a direction orthogonal to the first direction and the vertical direction is defined as a second direction, and one of two directions included in the second direction is defined as a third direction,
the first lifting mechanism and the first guiding mechanism being disposed at positions on one end side of the table in the first direction and are arranged in an aligned manner in the second direction,
the second lifting mechanism and the second guiding mechanism being disposed at positions on another end side of the table in the first direction and are arranged in an aligned manner in the second direction,
the first lifting mechanism being disposed at a position more toward the third direction than the first guiding mechanism,
the second guiding mechanism being disposed at a position more toward the third direction than the second lifting mechanism.

2. The printer according to claim 1, wherein a distance in the second direction between the first lifting mechanism and the first guiding mechanism is equal to a distance in the second direction between the second lifting mechanism and the second guiding mechanism.

3. The printer according to claim 1, wherein
the first lifting mechanism and the first guiding mechanism are adjacently arranged at positions in vicinity to or at center of the table in the second direction, and
the second lifting mechanism and the second guiding mechanism are adjacently arranged at positions in vicinity to or at center of the table in the second direction.

4. The printer according to claim 1, further comprising:
an inkjet head from which ink droplets are ejected toward the table,
a carriage mounted with the inkjet head and disposed at an upper position than the table; and
a carriage driving mechanism that moves the carriage in a main scanning direction orthogonal to the vertical direction, wherein
the first direction is the main scanning direction, and the second direction is a sub scanning direction.

5. The printer according to claim 1, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

6. The printer according to claim 1, wherein the printed matter is a three-dimensional object.

7. The printer according to claim 1, comprising:
a eject unit that ejects a resin filament softened by heating toward the table to form the printed matter, and
the printed matter is a three-dimensional object.

8. The printer according to claim 3, wherein
the first lifting mechanism and the first guiding mechanism are adjacently arranged at positions in vicinity to or at center of the table in the second direction, and
the second lifting mechanism and the second guiding mechanism are adjacently arranged at positions in vicinity to or at center of the table in the second direction.

9. The printer according to claim 2, further comprising:
an inkjet head from which ink droplets are ejected toward the table;
a carriage mounted with the inkjet head and disposed at an upper position than the table; and
a carriage driving mechanism that moves the carriage in a main scanning direction orthogonal to the vertical direction, wherein
the first direction is the main scanning direction, and the second direction is a sub scanning direction.

10. The printer according to claim 3, further comprising:
an inkjet head from which ink droplets are ejected toward the table;
a carriage mounted with the inkjet head and disposed at an upper position than the table; and
a carriage driving mechanism that moves the carriage in a main scanning direction orthogonal to the vertical direction, wherein
the first direction is the main scanning direction, and the second direction is a sub scanning direction.

11. The printer according to claim 8, further comprising:
an inkjet head from which ink droplets are ejected toward the table;
a carriage mounted with the inkjet head and disposed at an upper position than the table; and
a carriage driving mechanism that moves the carriage in a main scanning direction orthogonal to the vertical direction, wherein
the first direction is the main scanning direction, and the second direction is a sub scanning direction.

12. The printer according to claim 2, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

13. The printer according to claim 3, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

14. The printer according to claim 4, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

15. The printer according to claim 8, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

16. The printer according to claim 9, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

17. The printer according to claim 10, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

18. The printer according to claim 11, wherein
the first lifting mechanism and the second lifting mechanism each comprises a lead screw rotatably held by the table support, and a nut member attached to the table and engageable with the lead screw, and
the first guiding mechanism and the second guiding mechanism each have a guide rail attached to the table support, and a guide block attached to the table and engageable with the guide rail.

19. The printer according to claim 2, wherein the printed matter is a three-dimensional object.

20. The printer according to claim 3, wherein the printed matter is a three-dimensional object.
